(19) United States
(12) Patent Application Publication
(10) Pub. No.: US 2017/0027184 A1
(43) Pub. Date: Feb. 2, 2017

(54) PROCESS FOR PREPARING A CONFECTIONERY COMPOSITION

(71) Applicant: KRAFT FOODS R&D, INC., Deerfield, IL (US)

(72) Inventors: Xavier Wood, Bournville (GB); Rod Haines, St Ives (GB); Mark Mellors, St Ives (GB)

(21) Appl. No.: 15/102,862

(22) PCT Filed: Jan. 6, 2015
(86) PCT No.: PCT/IB2015/050097

§ 371 Date: Jun. 8, 2016

(30) Foreign Application Priority Data
Jan. 6, 2014 (GB) 1400133.3

(51) Int. Cl. A23G 3/34; A23G 3/54; A23G 1/40; A23G 1/54

(52) U.S. Cl. CPC A23G 3/007; A23G 1/545; A23G 3/545; A23G 1/40; A23V 2002/00

(57) ABSTRACT

A process for the production of a confectionery composition and a confectionery composition producible by the process. The process comprises introducing discrete droplets of a liquid filling (20) into a flowing matrix material (12) by means of an array of nozzles(16). The matrix material comprising the droplets of liquid filling is then deposited into a mould or a confectionery shell(14). The matrix material may be moving at a speed of at least 0.01 ms⁻¹. The matrix material may be chocolate and liquid filling filling may have a very low viscosity.

The present invention relates to a process for preparing a confectionery composition and compositions made thereby.

There is a continuing desire to provide new products and eating experiences for consumers. Liqueur filled chocolates are popular and provide a liquid sensation when the consumer bites through the chocolate shell and releases the filling. However, they are quite messy to consume. Conventional caramel filled chocolates are also popular but provide a different impact on the consumer due to the high viscosity of the caramel filling.

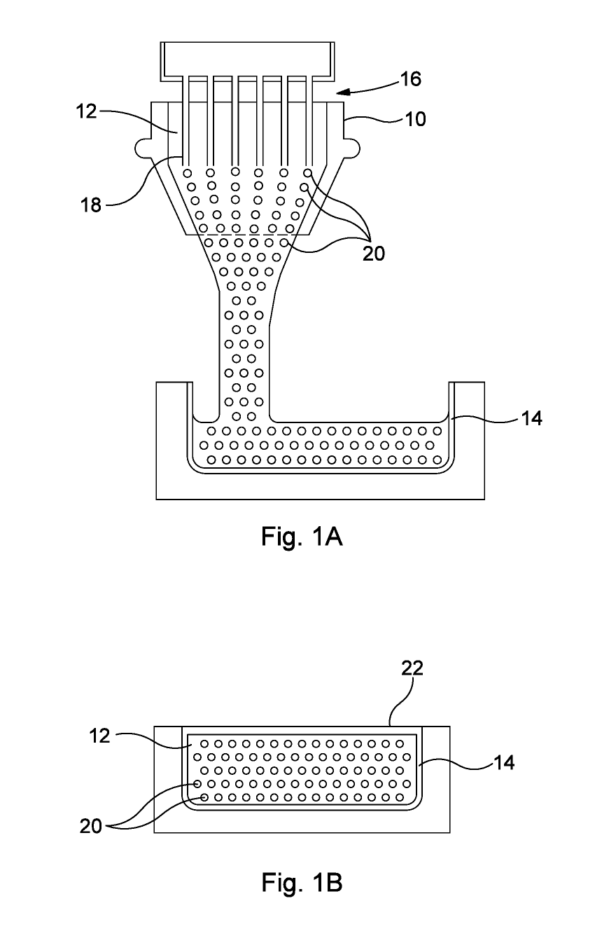

WO2010/031502 (NESTEC) describes a fat-based confectionery material with a continuous fat phase characterised in that the material is dispersed with bubbles containing a liquid filling. One method for producing the product is to introduce discrete droplets of a liquid filling into a flow of chocolate or other fat-based confectionery material, which is then moulded and solidified before the liquid droplets have had a chance to coalesce. An embodiment of the method is illustrated in FIG. 1 of WO'502 where a liquid filling is fed to a piston pump which forces the liquid through an array of fixed holes in a perforated plate into a flow of chocolate. A rotating valve plate is used to interrupt the flow of liquid through the fixed holes and so produce an output stream of discrete droplets.

According to the first aspect of the present invention there is provided a process for the production of a confectionery composition comprising

introducing discrete droplets of a liquid filling into a flowing matrix material by means of an array of nozzles; and

depositing the matrix material comprising the droplets of liquid filling into a mould or a confectionery shell.

The use of an array of nozzles is considered beneficial as compared to the use of a piston pump, perforated plate and rotating valve plate, as in WO2010/031502. The use of an array of nozzles allows the discrete droplets to be generated continuously. In contrast, a piston pump must stop to be refilled at regular intervals. Moreover, the rotating valve plate is considered to cause turbulence in the flow of chocolate.

The liquid filling is introduced into a flowing matrix material; the matrix material is moving rather than being confined within a mould. In one embodiment the flowing matrix material is moving at a speed of at least 0.01, 0.05, 0.1, 0.15, 0.2 or 0.25 ms⁻¹. The movement of the matrix material allows the nozzle array to remain stationary.

In one embodiment the nozzle array is arranged parallel to the direction of flow of the matrix material. In this way the droplets are dispensed from the nozzles and continue to move in the same direction within the flowing matrix material.

In an alternative embodiment the nozzle array is arranged perpendicular to the direction of flow of the matrix material. In this way the droplets change direction when they are dispensed from the nozzles.

The liquid filling is released from an array of nozzles. The liquid filling is supplied for a fixed period and then the supply is stopped; this is known as a pulse. In one series of embodiments, a pulse lasts less than 1, 0.5, 0.3, 0.1, 0.07, 0.05, 0.03 or 0.01 seconds. In one series of embodiments, a pulse lasts at least 0.01, 0.02, 0.03, 0.04, 0.5, or 0.7 seconds. The timing may be better understood by the pulse rate, the number of pulses in a given period. In one series of embodiments, the pulse rate is at least 5, 10, 15, 20, 25, 30, 35, 40 or 45 pulses per second (Hz). In one series of embodiments, the pulse rate is less than 60, 50, 40, 30, 25, 20 or 15 pulses per second.

The dimensions (size and the shape) of the droplets in the matrix material are partly determined by the size and the shape of the nozzles in the array. In one embodiment all of the nozzles in the array have identical dimensions. In this way, all of the resulting droplets will have the same dimensions. In another embodiment, the nozzles in the array have a variety of dimensions. In this way, the resulting droplets will have a variety of dimensions.

The following comments apply to at least one nozzle and/or the average properties of all of the nozzles in the array.

The nozzle(s) will typically be a cylindrical tube.

In one embodiment the nozzle(s) has/have an internal diameter of at least 1, 1.5, 2, 2.5, 3, 3.5, 4, 4.5 or 5 mm. In one embodiment the nozzle(s) has/have an internal diameter of less than 10, 8, 6, 5, 4, 3 or 2 mm. In a particular embodiment the nozzle(s) has/have an internal diameter of from 4 to 8 mm or from 5 to 7 mm.

In one embodiment the nozzle has/have a length of from 40 to 80 mm, from 50 to 70 mm or approximately 60 mm.

In one embodiment the nozzle array has a diameter of at least 15, 20, 25, 30, 35 or 40 mm. In one embodiment the nozzle array has a diameter of less than 45, 35 or 25 mm. In one embodiment the nozzle array has a diameter of approximately 30 mm.

In one embodiment the nozzles are arranged to form a circular array. A circular array of cylindrical nozzles provides a good packing density.

In one embodiment the nozzle array comprises at least 7, 19, 37 or 55 nozzles. In one embodiment the nozzle array comprises fewer than 70, 60, 50, 40, 30, 20 or 10 nozzles. In one embodiment the array comprises from 7 to 55 nozzles.

In one embodiment the nozzles in the array are spaced from one another by at least 1, 1.5, 2, 2.5, 3, 3.5, 4, 4.5 or 5 mm. In one embodiment the nozzles in the array are spaced from one another by less than 10, 8, 6, 5, 4, 3 or 2 mm.

The spacing of the nozzles in the array is better understood by comparison with the average diameter (D) of the nozzles in the array. In one embodiment the nozzles in the array are spaced from one another by at least 0.5, 0.75, 1, 1.25 or 1.5 average diameters. In one embodiment the nozzles in the array are spaced from one another by less than 2, 1.5, 1.25, 1 or 0.75 average diameters. In a particular embodiment the nozzles in the array are spaced from one another by approximately one average diameter.

The invention also resides in the products producible by the process of the first aspect of the invention.

In one embodiment the matrix material is deposited into a mould.

In one embodiment the matrix material is deposited into an edible shell. In one such embodiment the edible shell is a sugar-based confectionery shell or a fat-based confectionery shell. In one embodiment, the fat-based confectionery shell is a chocolate shell.

The dimensions (size and shape) of the mould/edible shell can vary from small bite-size pieces to large tablets. The present invention is particularly beneficial for larger products where a liquid filling would otherwise be very messy to consume.

In one embodiment the mould/edible shell has a length of at least 3, 4, 5, 6, 8, 10, 12, 15, 20 or 25 cm. In one embodiment the edible shell has a length of less than 30, 25, 20, 15 or 10 cm.

In one embodiment the edible shell has a thickness of at least 1, 2, 3, 4, 5, 6, 7, 8, 9 or 10 mm. In one embodiment the edible shell has a thickness of less than 15, 12, 8, 6, 5, 4, 3 or 2 mm. In one embodiment the edible shell has a thickness from 1 to 3 mm.

The viscosity of the liquid will affect the sensation perceived by the consumer; the lower the viscosity the more liquid the sensation. The viscosity of the liquid filling will also affect the size of the droplets that are generated by the array of nozzles. It is more difficult to generate small bubbles from liquid fillings having a high viscosity.

The viscosity of common foodstuffs is known from the literature. For example, the following values were obtained from a Viscosity Chart on the BASCO website: http://www.bascousa.com/images/advisors/407%20condensed.pdf.

| | Absolute | Temperature |
|---|---|---|
| | viscosity (cP) | (° F./° C.) |
| Butter fat | 42 | 110/43 |
| Butter fat | 20 | 150/66 |
| Cottage | 30000 | 65/18 |
| cheese | | |
| Cocoa butter | 50 | 140/60 |
| Cocoa butter | 0.5 | 210/99 |
| Condensed | 40-80 | 100-120/38-49 |
| milk | | |
| Condensed | 2160 | 70/21 |
| milk, 75% | | |
| solids | | |
| Cream, 45% | 48 | 60/16 |
| fat | | |
| Milk | 2.0 | 65/18 |
| Yoghurt | 152 | 105/41 |
| Caramel | 400 | 140/60 |
| Chocolate | 17000 | 120/49 |
| Chocolate | 280 | 120/49 |
| milk | | |
| Coffee, 30-40% | 10-100 | 70/21 |
| liquor | | |
| Corn syrup | 12000 | 130/54 |
| Gelatin, | 1190 | 110/43 |
| 37% solids | | |
| Fruit juice | 55-75 | 65/18 |
| Honey | 1500 | 100/38 |
| Mashed | 20000 | 100/38 |
| potato | | |
| Mayonnaise | 20000 | 70/21 |
| Molasses | 1400-13000 | 100/38 |
| Orange juice | 630 | 70/21 |
| concentrate | | |
| (30 brix) | | |
| Orange juice | 91 | 175/79 |
| concentrate | | |
| (30 brix) | | |
| Sorbitol | 200 | 70/21 |
| Toffee | 87000 | 100/38 |
| Tomato | 195 | 65/18 |
| paste, 30% | | |
| Olive oil | 40 | 100/38 |
| Palm oil | 43 | 100/38 |

The viscosity of the liquid filling should be greater than water but less than that of a conventional soft caramel. Viscosity can be described in a number of ways.

The liquid filling may be a Newtonian liquid or a non-Newtonian liquid. The viscosity of

Newtonian liquids is independent of the rate of shear (mixing) but changes with temperature (e.g. water, ethanol, glycerol). Non-Newtonian liquids (e.g. chocolate) are affected by the presence of solids in suspension so their viscosity depends on temperature and the rate of shear.

Viscosity can be measured using a rotational viscometer (or rheometer) such as the Bohlin, Brookfield or Haake viscometer. In one embodiment viscosity is measured using a Bohlin CV050 rheometer. In another embodiment viscosity is measured using a Brookfield RVD VIII Ultra rheometer

In one embodiment the liquid filling is a Newtonian liquid and has a viscosity measured at 25° C. of no more than 20, 15, 10, 5, 3, 2, 1.0, 0.50, 0.10, 0.01 or 0.001 Pa·s. In one embodiment the liquid filling is a Newtonian liquid and has a viscosity measured at 25° C. of at least 0.001, 0.01, 0.05, 0.1, 0.5, 1, 2, 3, 4 or 5 Pa·s In a particular embodiment the liquid filling has a viscosity at 25° C. of from 0.05 to 0.07. For comparison, water has a viscosity at 25° C. of approximately 8.94×10−4 Pa·s.

In one embodiment the liquid filling is a Newtonian liquid and has a viscosity measured at 25° C. of at least 0.001 Pa·s, at least 0.01 Pa·s, at least 0.1 Pa·s, at least 1 Pa·s or at least 5 Pa·s.

The viscosity of the liquid filling can be measured using a Bohlin CV050 rotational rheometer at a constant temperature of 25° C. The effect of shear can be determined by increasing the shear stress from 1 to 10 Pa.

In one series of embodiments the liquid filling has a viscosity measured at 10 s⁻¹ of less than 100, 85, or 60 Pa·s at 25° C.; of less than 50, 35 or 10 Pa·s at 35° C.; and/or less than 25, 15, 5 or 1 Pa·s at 45° C.

In one series of embodiments the liquid filling is a non-Newtonian liquid and has a viscosity measured at 30° C. of less than 15 Pa·s at 1 s⁻¹, less than 13 Pa·s at 10 s⁻¹ and/or less than 7 Pa·s at 100 s⁻¹.

The viscosity of the liquid filling can be described with reference to the Power Law (or Ostwald) Model. This fits a typical viscosity vs. shear rate curve and takes the form of:

y=Kxⁿ⁻¹

Where y=viscosity, x=shear rate, K=consistency coefficient (viscosity at a shear rate of 1 s⁻¹) and n=power law index (or flow law index).

n is a measure of how Newtonian the liquid is. A Newtonian liquid has n=1, such that y=K i.e. no change in viscosity with shear rate. For a shear thinning liquid n is greater than 0 but less than 1. For a shear thickening liquid n is greater than 1.

In one embodiment the liquid filling has a power law index (n) of from 0.8 to 1.2 or from 0.9 to 1.1. The power law index (n) can be calculated using the following protocol (provided by Brookfield):

Instrument: Brookfield RVDVIII Ultra rheometer fitted with a Small Sample adaptor and spindle/chamber 5C4-15/7R. Temperature: 25° C. RPM down-ramp: 50, 40, 30, 20, 10, 5, 2.5, 1.5. 1 minute hold at each speed before recording viscosity value. Plot Viscosity vs Shear rate to determine n.

The pour point of a liquid is the lowest temperature at which it will pour before it becomes semi-solid and loses its flow characteristics. In one embodiment the liquid filling has a pour point of less than 25, 20, 15, 10, 5 or 3° C.

The liquid filling can be any liquid confectionery material which is liquid at standard ambient temperature and pressure (SATP) and includes an aqueous solution, a water-in-oil emulsion or an oil-in-water emulsion. It will be understood that the liquid filling must be edible.

In one embodiment, the liquid filling is selected from the group comprising fruit juice; vegetable juice; fruit puree; fruit pulp; vegetable pulp; vegetable puree; honey; sugar syrup; polyol syrup; hydrogenated starch hydrolysates syrup; emulsions; vegetable oil; glycerin; propylene glycol; ethanol; liqueurs; chocolate syrup, ganache, caramel, dairy-based liquids such as milk, cream, etc.; fondant; an isomalt-comprising solution; and combinations thereof. In one such embodiment the liquid filling is selected from the group consisting of fruit juice; vegetable juice; fruit puree; fruit pulp; vegetable pulp; vegetable puree; fruit sauce; vegetable sauce; sugar syrup; polyol syrup; glycerin; caramel and combinations thereof.

In one embodiment the liquid filling is a flavoured sugar or sugar substitute syrup. In one such embodiment the syrup comprises bulk sweetener (e.g. sucrose or polyol), water and flavouring. In one embodiment the sugar or sugar substitute syrup has a solids content of no more than 75%, no more than 60%, no more than 50 or no more than 40%. A reduction in solids content is expected to reduce the viscosity of the liquid filling and thereby provide a greater contrast with the solid chocolate capsule. In one embodiment the liquid filling is selected from one or more of almond, apple, apricot, banana, basil, butterscotch, blueberry, caramel, cardamom, cherry, chocolate, hazelnut, kiwi, lime, mango, melon, orange, peach, raspberry, strawberry, vanilla syrup. Suitable syrups are commercially available and include those sold under the Monin® brand.

Sugars include sucrose, glucose, fructose, lactose and maltose and any combination thereof). Sugar substitutes include sugar alcohols such as sorbitol, xylitol, mannitol, lactitol and isomalt.

The liquid filling may additionally comprise colourings and/or flavourings. In one embodiment the liquid filling additionally comprises pharmaceutical additives such as medicaments, breath fresheners, vitamins, minerals, caffeine, and mixtures thereof.

A low water activity will assist in rendering the liquid filling microbiologically stable. In one embodiment the liquid filling has a water activity measured at 25° C. of 1 or less than 1.0, 0.95, 0.9, 0.8, 0.7, 0.65 or 0.60.

In one embodiment the matrix material is a fat-based confectionery material or a sugar-based confectionery material. In one embodiment the matrix material is chocolate. In one embodiment the matrix material is fondant. In one embodiment the matrix material is aerated.

The term ‘chocolate’ in the context of the present invention is not restricted by the various definitions of chocolate provided by government and regulatory bodies. A ‘chocolate’ may be a dark chocolate, a milk chocolate or a white chocolate.

The chocolate for the matrix material/edible shell comprises at least one fat. The fat may be cocoa butter, butterfat, a cocoa butter equivalent (CBE), a cocoa butter substitute (CBS), a vegetable fat that is liquid at standard ambient temperature and pressure (SATP, 25° C. and 100 kPa) or any combination of the above. In a particular embodiment, the chocolate comprises cocoa butter.

CBEs are defined in Directive 2000/36/EC. Suitable CBEs include illipe, Borneo tallow, tengkawang, palm oil, sal, shea, kokum gurgi and mango kernel. CBE's are usually used in combination with cocoa butter. In one embodiment, the chocolate comprises no more than 5 wt % CBE's.

The chocolate may comprise a cocoa butter substitute (CBS) (sometimes known as a cocoa butter replacer, CBR) in place of some or all of the cocoa butter. Such chocolate materials are sometimes known as compound chocolate. Suitable CBS's include CBS laurics and CBS non-laurics. CBS laurics are short-chain fatty acid glycerides. Their physical properties vary but they all have triglyceride configurations that make them compatible with cocoa butter. Suitable CBS's include those based on palm kernel oil and coconut oil. CBS non-laurics consist of fractions obtained from hydrogenated oils. The oils are selectively hydrogenated with the formation of trans acids, which increases the solid phase of the fat. Suitable sources for CBS nonlaurics include soya, cottonseed, peanut, rapeseed and corn (maize) oil.

In one embodiment the chocolate comprises fat (e.g. cocoa butter or a cocoa butter equivalent or cocoa butter substitute), a bulk sweetener (e.g. a sugar or sugar substitute) and non-fat cocoa solids (e.g. from cocoa liquor or cocoa mass).

The chocolate may comprise at least one vegetable fat that is liquid at standard ambient temperature and pressure (SATP, 25° C. and 100 kPa). Suitable vegetable fats include corn oil, cotton seed oil, rapeseed oil, palm oil, safflower oil, and sunflower oil.

The present invention is further applicable to chocolate in which some or all of the fat is constituted by a partly or wholly non-metabolisable fat, for example Caprenin.

Embodiments of the invention will now be described by way of example only in which:

FIG. 1A is a diagram showing a process in accordance with an embodiment of the invention;

FIG. 1B is a cross-section of the product of the process shown in FIG. 1A;

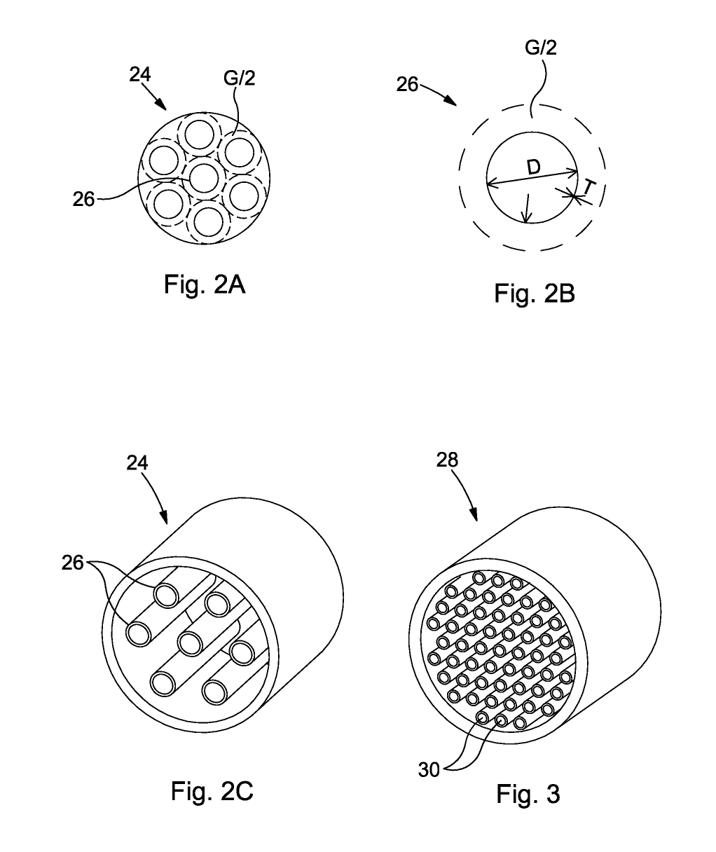

FIG. 2 shows a nozzle array for use in a process in accordance with an embodiment of the invention; and

FIG. 3 shows another nozzle array for use in a process in accordance with an embodiment of the invention.

Referring to FIG. 1A there is shown a hopper 10 comprising molten chocolate 12. The hopper has an aperture in its base, through which the molten chocolate 12 flows into a pre-formed chocolate shell 14. An array of nozzles 16 is arranged so that each nozzle 18 extends into the hopper 10. Discrete droplets of a liquid filling 20 are pulsed from the nozzles 18 into the flow of molten chocolate 12. The molten chocolate 12 comprising the droplets of liquid filling 20 is then deposited into the chocolate shell 14.

The nozzle array 16 is arranged parallel to the direction of flow of the molten chocolate 12. The droplets 20 travel in the same direction as they pass through the nozzles 18, into the molten chocolate and into the shell 14.

The shell 14 containing the chocolate 12 and the droplets of liquid filling 20 is subsequently backed off with additional chocolate 22 as shown in FIG. 1B.

FIG. 2A shows a circular nozzle array 24 found to be suitable for use in the process of the invention. The array 24 comprises 7 nozzles 26 in total; one nozzle at the centre and the remaining 6 equally spaced around in a circle. The nozzles 26 are spaced from one another by a distance G. The inventors have found that G should be at least 2 mm to prevent coalescence of the droplets; G is 4.5 mm in this case.

A single nozzle 26 is shown in FIG. 2B. The nozzle has an internal diameter D of 4.4 mm and a wall thickness T of 0.2 mm. The nozzle 26 is a cylindrical tube having a length of 60 mm. The internal diameter D corresponds approximately to the diameter of the resulting droplets.

FIG. 2C shows a perspective view of the nozzle array 24 comprising nozzles 26.

FIG. 3 shows another circular nozzle array 28 for use in the invention. The array 28 comprises 55 nozzles 30. Each nozzle 30 is a cylindrical tube of length 60 mm and internal diameter 1.9 mm. There is a gap of 2 mm between nozzles 30 which equates to one average diameter.

### METHODOLOGY

The viscosity of a liquid filling was determined using a Bohlin CV050 rheometer at constant temperature (25° C.) with shear stress being increased from 1 to 10 Pa. The following example shows the measurement of the viscosity of a commercially available caramel syrup (Le sirop de Monin® caramel, available from Monin (Bourges, France)). The syrup has the following ingredients: sugar, water, flavouring, natural plant extracts, colouring agent: E150a, acidifying agent: citric acid.

Viscosity @ 25° C. (Pa · s)

| Shear Rate (1/s) | Shear Stress (Pa) | Viscosity (Pa · s) |
|---|---|---|
| 16.3 | 1 | 0.0612 |
| 20.9 | 1.29 | 0.0617 |
| 26.7 | 1.67 | 0.0624 |
| 34.3 | 2.15 | 0.0628 |
| 44.1 | 2.78 | 0.0631 |
| 56.6 | 3.59 | 0.0634 |
| 72.9 | 4.64 | 0.0636 |
| 94.2 | 5.99 | 0.0636 |
| 121.5 | 7.74 | 0.0638 |
| 156.5 | 10 | 0.0639 |

It can be seen that the viscosity of the caramel changes only slightly as the shear rate increases from 16.3 to 156.5 s⁻¹; it is around 0.06 Pa·s under the conditions of measurement.

### EXAMPLE 1

A chocolate bar consisting of a chocolate shell having filling, the filling being chocolate with caramel dispersed throughout in the form of droplets.

The chocolate is a conventional milk chocolate. The caramel (liquid filling) is as described above. The droplets of caramel (approximate diameter 4.5 mm) were dispersed in a flow of molten chocolate as shown in FIG. 1 using the nozzle array shown in FIG. 2. The caramel was pulsed at a rate of 15Hz and the chocolate containing the droplets of caramel was deposited into a chocolate shell. The caramel constituted 15% of the filling in the chocolate shell.

### EXAMPLE 2

A chocolate bar consisting of a chocolate shell having a filling being chocolate with a raspberry syrup dispersed throughout in the form of droplets.

The chocolate is a conventional milk chocolate. The raspberry syrup (liquid filling) had water activity 0.7, viscosity: Newtonian, 0.06 at 25° C. and density 1333 kg/m³. The droplets of raspberry syrup (approximate diameter 1.8 mm) were dispersed in a flow of molten chocolate as shown in FIG. 1 using the nozzle array shown in FIG. 3. The raspberry syrup was pulsed at a rate of 41 Hz and the chocolate containing the droplets was then deposited into a chocolate shell. The raspberry syrup constituted 15% of the filling in the chocolate shell.

1. A process for the production of a confectionery composition comprising
introducing discrete droplets of a liquid filling into a flowing matrix material by means of an array of nozzles; and
depositing the matrix material comprising the droplets of liquid filling into a mould or a confectionery shell.

2. The process of claim 1, wherein the flowing matrix material is moving at a speed of at least 0.01 ms⁻¹.

3. The process of claim 1, wherein the array of nozzles dispenses the discrete droplets of liquid filling at a pulsation frequency of at least 10 Hz.

4. The process of claim 1, wherein at least one nozzle has an internal diameter of from 1 to 5 mm.

5. The process of claim 1, wherein the array of nozzles comprises from 7 to 55 nozzles.

6. The process of claim 1, wherein the edible shell is a chocolate shell.

7. The process of claim 1 wherein the liquid filling is selected from one or more of fruit juice; vegetable juice; fruit puree; vegetable puree; fruit sauce; vegetable sauce; honey; corn syrup; sugar syrup; polyol syrup; hydrogenated starch hydrolysates syrup; emulsions; vegetable oil; glycerin; propylene glycol; ethanol; liqueurs; ganache, dairy- based liquids, fondant and an isomalt-comprising solution.

8. The process of claim 1, wherein the liquid filling is a flavoured sugar or sugar-substitute syrup.

9. The process of claim 1, wherein the liquid filling is caramel.

10. The process of claim 1 where the liquid filling has a pour point of less than 10° C.

11. The process of claim 1, wherein the liquid filling has a viscosity measured at 25° C. of no more than 5 Pa·s.

12. The process of claim 1, wherein the matrix material is chocolate.

13. The confectionery composition producible by the process of claim 1.
